(19) United States
(12) Patent Application Publication
(10) Pub. No.: US 2023/0199168 A1
(43) Pub. Date: Jun. 22, 2023

(54) TEST SETUP AND METHOD FOR TESTING A CONTROL UNIT

(71) Applicant: dSPACE GmbH, Paderborn (DE)

(72) Inventors: Jochen SAUER, Paderborn (DE); Caius SEIGER, Paderborn (DE)

(21) Appl. No.: 18/068,535

(22) Filed: Dec. 20, 2022

(30) Foreign Application Priority Data
Dec. 21, 2021 (DE) 102021133971.5

(51) Int. Cl. H04N 17/00; H04N 17/02

(52) U.S. Cl. CPC H04N 17/002; H04N 17/02

(57) ABSTRACT

A system includes: a camera unit; a control unit; and a test setup for testing the control unit. The test setup comprises a processor and an image output unit. The processor is configured to manipulate image data to simulate an error of the camera unit and to output, on the image output unit, the manipulated image data in the form of an image detectable via camera optics. The camera unit is configured to detect, via the camera optics, the outputted image data simulating the error of the camera unit. The control unit is configured to receive, from the camera unit, camera image data simulating the error of the camera unit.

### CROSS-REFERENCE TO PRIOR APPLICATIONS

This application claims benefit to German Patent Application No. DE 102021133971.5, filed on Dec. 21, 2021, which is hereby incorporated by reference herein.

### FIELD

The application relates to a test setup and a method for testing a control unit for a vehicle.

### BACKGROUND

Control units in motor vehicles may have a computing unit, memory, interfaces and possibly further components, which are required for the processing of input signals with input data into the control unit and the generation of control signals with output data. The interfaces serve to receive the input signals or output the control signals.

Control units for driving functions in advanced driver assistance systems (ADDAS=Advanced Driver Assistance Systems), e.g. for autonomous or partially autonomous driving, may obtain image data of a camera unit as input data. In a camera unit camera optics as an optical system ensures that an optical imaging of the environment is generated. A lens and a camera chip, also called an imager, may be part of such camera optics. Camera optics can also have more than one lens and/or further optical elements.

One possibility for testing control units, which evaluate image data of a camera unit, includes testing the control units having the corresponding camera units in the installed state, for example in the motor vehicle as part of test drives. This is complicated, cost-intensive, and many situations in a real environment cannot be verified, since they occur only in extreme cases, for example in accidents. Therefore, corresponding control units are tested in artificial environments, for example in test benches. A frequent test scenario here is to test the functionality of a control unit via a simulated environment, i.e. based on a virtual spatial environment model. To this end, the environment of the control unit is calculated in real time partially or even entirely via a powerful simulation environment. The simulation environment frequently records the output signals that are then generated by the control unit and lets them flow into a further real-time simulation. Control units may thus be tested safely in a simulated environment under practically real conditions. How real the test is depends on the quality of the simulation environment and the simulation calculated thereon. Control units may thus be tested in a closed control loop, which is why such test scenarios are also called hardware-in-the-loop (HiL) tests. Other types of relevant test scenarios are software-in-the-loop (SiL) tests, with which a software program to be tested is executed on a virtual hardware, for example on a virtual control unit, and can thus be tested, or model-in-the-loop (MiL) tests, which serve for model verification, that is to say of mathematical models of technical-physical systems. The simulation environment can generate synthetic image data, which simulate the virtual environment of the control unit.

Another possibility for testing control units is to use recorded image data instead of synthetic image data generated on the basis of a simulated environment. In this case, image data generated during a real test run by a real camera of the test vehicle and recorded via a data recorder are fed to a control unit, in order to test the reaction of the control unit to the recorded image data. This technique is also known as “data replay.”

CN111399480A describes a hardware-in-the-loop test setup that applies virtual sensors to supply the control unit to be tested with synthetic image data. The test setup has an error feed unit that supplies the control unit with sensor errors selectively on a virtual or physical level, in order to test the reaction of the control unit to a faulty sensor.

### SUMMARY

In an exemplary embodiment, the present invention provides a system. The system includes: a camera unit; a control unit; and a test setup for testing the control unit. The test setup comprises a processor and an image output unit. The processor is configured to manipulate image data to simulate an error of the camera unit and to output, on the image output unit, the manipulated image data in the form of an image detectable via camera optics. The camera unit is configured to detect, via the camera optics, the outputted image data simulating the error of the camera unit. The control unit is configured to receive, from the camera unit, camera image data simulating the error of the camera unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a test setup for testing a control unit with a camera unit and the control unit; and

FIG. 2 schematically shows a method for testing a control unit.

### DETAILED DESCRIPTION

Exemplary embodiments of the application provide an improved error feed for the control unit test.

Exemplary embodiments of the application include a test setup and a method.

A control unit to be tested, e.g. for a motor vehicle, is configured to receive camera image data output by a camera unit. A test setup for testing such a control unit has a processor and an image output unit, wherein the processor is configured to output image data in the form of an image that can be detected via camera optics on the image output unit. The camera unit is designed and arranged to detect the output image data via camera optics. The camera optics is a component of the camera unit. In this type of testing, the camera unit itself can be completely functional by itself. The errors are generated by the processor and are then located within the image data, which are output on the image output unit and are optically detected by the camera unit.

The processor of the test setup is configured to manipulate the synthetic image data output on the image output unit in such a way that the camera image data output by the camera unit simulate an error of the camera unit. The image data may be synthetic image data generated by the processor, which is, in particular, generated by rendering a simulated environment. In this case, the errors may be incorporated directly during rendering into the image data. The image data may also be recorded image data that do not natively comprise any errors and are subsequently manipulated by the processor.

The image output unit is in particular a screen or monitor on which optical and thus visually perceptible information may be displayed. The output of the image data can correspond to rendering digital image data on the monitor. The camera optics of the camera unit are configured to detect such optical information and to map them onto an image, in particular in the form of digital image data. The camera lens system comprises the region from the first lens of the camera unit to the imager and optionally to a camera processor downstream of the imager for processing the raw data output by the imager. The camera processor can optionally be provided for carrying out a neural network, for example, which can be used for object recognition, for example. The camera processor can optionally be a component of the camera unit or alternatively be connected downstream of the camera unit.

The camera unit is connected via the camera image data that can be output by the same in conjunction with the control unit, which is configured to record and further process the camera image data as input data.

The processor of the test setup is configured to generate the synthetic image data and to output them on the image output unit. The synthetic image data are image data that were produced synthetically, i.e. by computing operations of the processor, in particular on the basis of a virtual model of the camera unit and/or of the simulation model of a virtual environment of the control unit. The virtual model of the camera unit has to reproduce the real camera unit as accurately and precisely as possible. In order to generate the synthetic image data, the processor can, in particular, also be based on input data from other computing units that it receives via an input interface.

The test setup makes it possible to simulate an error of the camera unit in that the processor manipulates the synthetic image data such that the camera image data that is output by the camera unit, which optically detects the image data, look like the camera unit would have an error.

This enables a comprehensive test of the control unit in response to different errors of the camera unit. In particular, errors that have to be tested may be fed into the test setup via a foreseeable error-feeding interface of the processor. Depending on the desired error to be fed in, the processor can in turn manipulate the synthetic image data in a targeted manner, so that the camera image data output by the camera unit look like as the camera unit would have the error fed into the test setup via the error-feeding interface. Test cases may be selected and fed in, for example, using a test catalog. The reaction of the control unit can be detected and evaluated.

In the context of this application, the control unit can be understood to be a real control unit with a real control unit computing unit that can receive camera image data from the camera unit. This is the HiL case. Alternatively or additionally, the control unit can be understood to be a real software program that runs on a virtual control unit and receives the camera image data from the camera unit. This is the SiL case. The test bench is applicable to both cases. In the same way, the test bench is applicable for MiL cases.

The errors of the camera unit, which are simulated, may in particular relate to an electrical error of the camera unit. Electrical errors relate to failure or malfunction of a signal line. Electrical errors are, for example, errors that are caused by errors in electrical connections of the camera unit, for example due to interruptions of electrical connections and/or due to the creation of unwanted and non-provided electrical connections. In this context, electrical errors may in particular be a failure of the camera unit, a short circuit, a grounding error, a short circuit between pins of the camera unit and/or a conductor or cable break.

The advantage of the simulation of electrical errors is that such electrical errors may be simulated without providing a separate unit that actually physically causes such errors. The feeding of electrical errors can take place in a virtual way, which helps to reduce costs and increase flexibility.

In an embodiment, the camera unit has a lens and an imager. The lens and the imager are a component of the camera optics that represents an optical system that generates an optical image of the environment. The raw data output by the imager reflects the optical image of the environment in the form of unprocessed digital image data. In this embodiment, the camera image data output by the camera unit contain raw data output by the imager. The output camera image data may look as if the camera unit would have an error. An error of the camera unit can thus be simulated via the output camera image data.

In an embodiment, the camera unit has a lens, an imager and a camera processor for processing the raw data output by the imager. The lens and the imager are a component of the camera optics. The raw data output by the imager is often followed by a processor, for example as object recognition and/or for generating control commands in response to the recognition of objects. This post-processing of the raw data can take place, for example, in the form of a neural network, e.g. in the form of a classifier, e.g. as object recognition. The camera processor can be provided for implementing the neural network and for executing the computing operations of the neural network. In this embodiment, the camera image data output by the camera unit contain image data processed and output by the camera processor. The output camera image data may look as if the camera unit would have an error. An error of the camera unit can thus be simulated via the output camera image data. The camera unit according to this exemplary embodiment can be provided, for example, as an integrated camera unit, in particular as a system-on-chip (SoC) camera unit integrated on a chip. The proposed error feed via the image output unit, the image output of which is detected by the camera optics, is particularly advantageous for such an SoC camera unit, since errors of the camera unit may be simulated without modifying the chip. In many cases, such access to the chip and its possible modification are also not present at all.

In an embodiment of the test setup, the error relates to the failure of at least one color channel. In particular, for example, the rupture of one of the RGB color signal cables can be simulated in that the respective color affected by cable break is removed from the image data represented on the image output unit. The camera unit then records the image data via its camera optics and in turn outputs camera image data, which do not contain the respective affected color. As a result, the error is simulated without the need for such a cable to be actually physically interrupted.

An electrical error can also relate to individual pixels or pixel regions of the imager, which then fail accordingly. The error simulation then accordingly represents on the image output unit the image data without this pixel or pixel regions, so that the corresponding error is simulated in the camera image data. In addition to individual pixels, pixel errors may also relate to the entire area of the imager, a partial region of the imager, e.g. 25%, but also individual or multiple image lines. In this way, failures and/or partial failures of the imager may be simulated.

In this embodiment, it is particularly advantageous if the resolution of the image output unit is greater than that of the imager, in order to enable the simulation of failures of individual selected pixels. In particular, the camera unit should have a position relative to the image output unit, which is well defined and adjusted. This is necessary in order to be able to assign pixel regions on the image output unit at least approximately to the pixels of the imager.

Alternatively or additionally, the error can relate to at least one lens error. A lens error can also relate to damage or contamination of the lens, cracks in the lens and/or dirt spots on the lens. These lens errors may also be reproduced on the image output unit, in particular by inclusion of blurring and/or scattering effects.

In an embodiment of the test setup, the processor is configured to generate synthetic image data that simulate predetermined errors of the camera unit. By specifying certain errors, the error feed can be systematized and, for example, different test patterns may be generated, which may then be similarly applied to different variants of control units or to different virtual environments of the control unit.

In an embodiment of the test setup, the predetermined errors are stored in a database with which the processor is connected via a communication interface. The predetermined errors are stored here, for example, in an error database that can be connected to the processor, for example via a communication network.

In an embodiment, a higher level intelligence communicates with the processor of the test setup. The communication is provided via the communication interface, which can be designed in particular as a network. The higher level intelligence is set up and provided to control the simulation of the errors in that, for example, it reads out, based on error models, sequences of predetermined errors from the error database and feeds them into the test setup in a targeted manner. This allows a further systematization of the testing. In particular, it can be provided that the higher level intelligence executes the tests in an automated manner.

A method for testing a control unit comprises the following steps:
a) generating synthetic image data detectable via camera optics,
b) outputting the synthetic image data on an image output unit,
c) detecting the image data output on the image output unit via the camera optics of a camera unit,
d) outputting camera image data by the camera unit,
e) receiving the camera image data by the controller.

The synthetic image data are designed such that the camera image data output by the camera unit simulate an error of the camera unit.

The method is particularly suitable for the previously described test setup with the processor and image output unit in conjunction with the previously described camera unit and the previously described control unit.

In an embodiment of the method, the response of the control unit to the simulated error of the camera unit is detected and transmitted to a higher level entity. The higher level entity may correspond to the above-described higher level intelligence that is connected to the test setup, e. g., via a communication interface.

The application is further explained and described in the following with reference to exemplary embodiments illustrated in the figures.

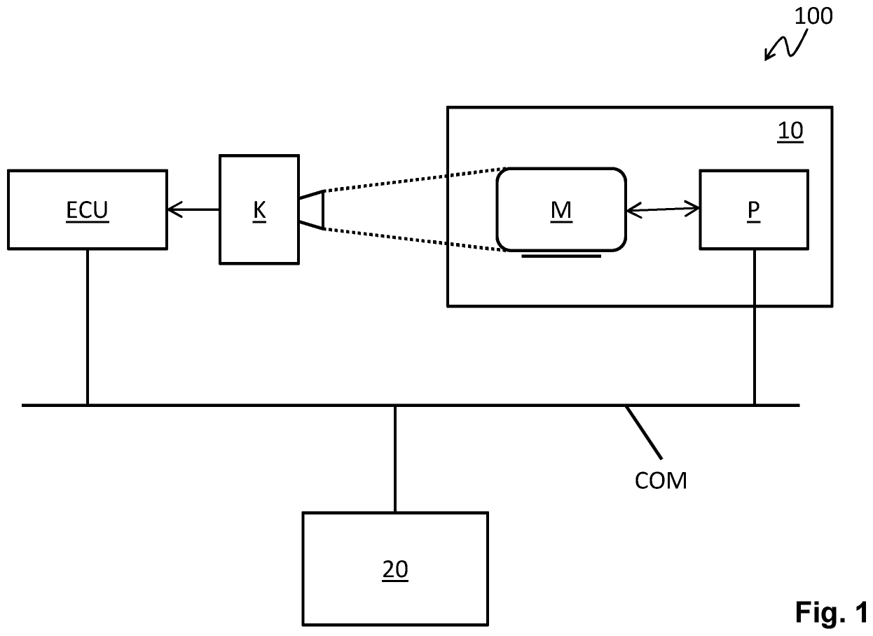

FIG. 1 shows a test bench 100 with a test setup 10 for testing a control unit ECU.

The control unit ECU is to be tested in the test bench 100. Its functionality is to be tested via a simulated environment, i.e. via a virtual spatial environment. To this end, the environment of the control unit ECU is calculated partially or even entirely in real time via a powerful simulation environment, which can be arranged, for example, in the higher level intelligence 20. Often the simulation environment picks up the output signals that are then generated by the control unit ECU and lets them flow into a further real-time simulation. Such a test bench 100 provides a virtual environment for the control unit ECU via the simulation of the environment through physical models and operates with control loops. The physical models of the virtual environment respond to the output signals of the control unit ECU to be tested, similar to the real environment. As a result, the control loops, one part of which is the control unit ECU, can be checked for proper functioning.

In the exemplary embodiment shown in FIG. 1, the control loops are implemented via the communication interface COM. The communication interface can be designed, for example, in a wireless or wired manner, e.g. in the form of a data bus.

In the exemplary embodiment shown, the control unit ECU is intended to be tested with a real camera unit K. The camera unit K is therefore actually present. The control unit ECU receives camera image data of the camera unit K as input data. The camera unit K has camera optics, via which it can generate an optical image of its environment. The camera optics of the camera unit K include at least one lens and one camera chip, called an imager. The imager generates raw data as digital image data as output data.

In an embodiment, the camera unit K has the camera optics with lens and imager and outputs raw data as camera image data to the control unit ECU. In such an embodiment, the control unit ECU is preferably capable of further processing the raw data, i.e. for example to carry out object recognition and to generate control commands based on object recognition.

In another embodiment, the camera unit K can optionally have a camera processor that receives and further processes the raw data from the imager. The further processing by the camera processor can have further processing steps. For example, the camera processor can further process the raw data via an algorithm that performs object recognition on the basis of the raw data. Machine learning, e.g. deep learning, can be used for this purpose. In particular, the camera processor can optionally also generate control commands for the control unit ECU on the basis of the object recognition. The camera processor is an optional component of the camera unit K, as can be implemented for example in the case of camera units K in the system-on-chip design. In the system-on-chip (SoC) design, electrical lines and other components of the camera unit K may be installed on a chip in a closed system. Access to individual lines, for example to simulate an error there, is no longer possible.

In this embodiment with a camera processor as a component of the camera unit, the camera processor outputs the image data processed by it as camera image data to the control unit for further processing. In this exemplary embodiment, the camera image data may thus also contain information regarding recognized objects and/or control commands.

The test setup 10 comprises a processor P and an image output unit M, e. g., in the form of a screen or monitor. The processor P of the test setup 10 is configured to generate synthetic image data and output it on the image output unit M. The synthetic image data are part of the virtual environment of the control unit ECU. The synthetic image data generated by the processor appear, e. g., as video film-like sequences on the image output unit. The camera unit K is aligned and adjusted to the image output unit in such a way that it can detect the image data that are displayed thereon with its camera optics. The control unit ECU is able to detect the video film-like sequences and the virtual environment shown on them via the camera unit K and can respond accordingly. The output data of the control unit ECU can be analyzed in order to check whether the control unit responds as desired to the video sequence output on the image output unit M. The reaction of the control unit ECU can then in turn be fed into the physical model of the virtual environment. This can in turn influence the synthetic image data on the image output unit M. The control loop mentioned above can thus be closed.

It is advantageous to also be able to simulate errors of the camera unit K in order to be able to test the reaction of the control unit ECU to such errors. For this purpose, the processor P is configured to manipulate the synthetic image data generated by it and output on the image output unit M in such a way that the camera unit K outputs camera image data that simulate an error of the camera unit K. The camera image data output by the camera unit K has in turn been generated on the basis of the synthetic image data output on the image output unit M. For error simulation, the camera unit K can therefore continue to operate without errors. It is not necessary to manipulate it, in particular, no access to electrical lines of the camera unit is necessary for generating electrical errors. This is particularly advantageous in the case of integrated camera units, e.g. those in a system-on-chip design.

Simulated errors of the camera unit K may in particular relate to an electrical error of the camera unit K. Electrical errors relate to failure or malfunction of a signal line. Electrical errors are, for example, errors that are caused by errors in electrical connections of the camera unit K, for example due to interruptions of electrical connections and/or due to creation of unwanted and non-intended electrical connections. In this context, electrical errors may in particular be a failure of the camera unit K, a short circuit, a grounding error, a short circuit between pins of the camera unit K and/or a conductor or cable break.

An electrical error of the camera unit K can also relate in particular to the failure of at least one color channel. In particular, for example, the rupture of one of the RGB color signal cables can be simulated in that the respective color affected by cable rupture is removed from the image data shown on the image output unit M. The camera unit K then records the image data via its camera optics and in turn outputs camera image data that do not contain the respective affected color. As a result, the error is simulated without the need for such a cable to be actually physically interrupted.

An electrical error can also relate to individual pixels or pixel regions of the imager, which then fail accordingly. The error simulation then accordingly represents on the image output unit the image data without this pixel or pixel regions, so that the corresponding error is simulated in the camera image data. In addition to individual pixels, pixel errors may also relate to the entire area of the imager, a portion of the imager, e.g. 25%, but also stripes. In this way, failures and/or partial failures of the imager may be simulated. For the simulation of such errors, it is particularly advantageous if the resolution of the image output unit is greater than that of the imager, so that the errors of pixels may also be displayed with sufficient resolution. In particular, the camera unit should have a position relative to the image output unit, which is well defined and adjusted. This is necessary to be able to assign pixel regions on the image output unit at least approximately to the pixels of the imager.

Alternatively or additionally, a lens error can be simulated. A lens error can relate, for example, to damage or contamination of the lens, cracks in the lens and/or dirt spots on the lens. These lens errors may also be reproduced on the image output unit, in particular by inclusion of blurring and/or scattering effects. Such errors may also be simulated by designing the test setup in combination with the camera unit K and the control unit ECU.

Such a test bench 100 enables, for example, the simulation of a control unit ECU for autonomous driving and/or semi-autonomous driving. For this purpose, trajectories of the affected vehicle and nearby vehicles may be calculated as part of the virtual environment in the higher level intelligence 20, for example. The images that the camera unit K of the control unit ECU would “see,” i.e. record, in this virtual environment, are transmitted as synthetic image data to the processor P of the test setup 10, for example via the communication interface COM. Based on these synthetic image data, the processor P then calculates synthetic image data for displaying on the image output unit M, simulating the errors of the camera unit K. For this purpose, the processor P uses data on desired errors that were transmitted to it by an error-feeding interface. Using these data from the error-feeding interface and the synthetic raw data of the virtual environment to be displayed, the processor P then calculates the synthetic image data for display on the image output unit M, which simulate errors of the camera unit K.

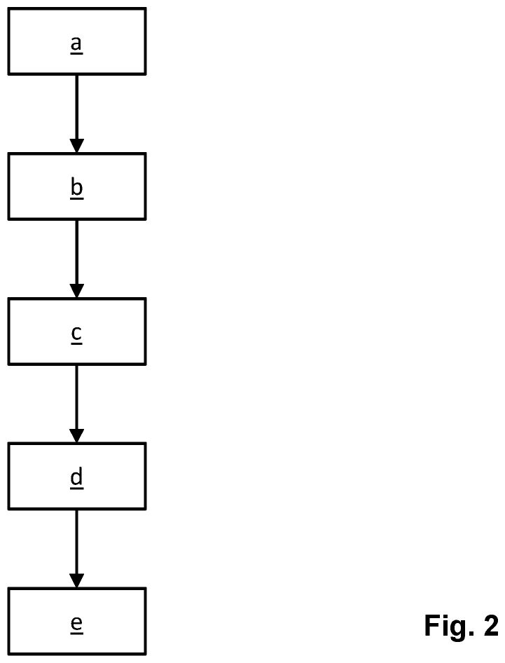

FIG. 2 shows by way of example a method for testing the control unit ECU with the steps:
a) generating, by the processor P, synthetic image data detectable via the camera optics,
b) outputting the synthetic image data on the image output unit M,
c) detecting the image data output on the image output unit M by the camera optics of the camera unit K,
d) outputting the camera image data by the camera unit K,
e) receiving the camera image data by the controller ECU.

The synthetic image data are designed such that the camera image data output by the camera unit K simulate an error of the camera unit K. In a further step, the reaction of the control unit to the simulated error of the camera unit K can then be detected and transmitted to the higher level intelligence 20.

This enables extensive tests of the control unit ECU in response to different errors of the camera unit K. in particular, errors required to be tested may be fed via the foreseeable error-feeding interface of the processor P into the test setup 10. Depending on the error required to be simulated, the processor P can in turn manipulate the synthetic image data in a targeted manner, so that the camera image data output by the camera unit K look as if the camera unit K would have the error fed into the test setup via the error-feeding interface. The error feed can take place in particular via the communication interface COM. Test cases may be selected and fed in, for example, using a test catalog. The reaction of the control unit ECU can be detected and evaluated. The test catalog is preferably stored in a database that can be a component of the test bench 100 and that can likewise be connected via the communication interface COM to the test setup 10. The higher level intelligence 20 preferably controls the test sequence. For example, the higher level intelligence 20 can also have direct access to the database with the test cases and/or can be connected to the database via a direct data connection.

As a result, it is possible to configure the test simulation to be reusable and, for example, to reuse it for different test benches with other control units ECU. The test cases for the simulation of the camera unit are reusable. It is also possible to extend the test bench and to simultaneously test a plurality of control units, also in a regulating network.

By using such a higher level test simulation, it is also possible to apply the same test scenarios to HiL, SiL, etc., which may operate either with real sensors, as described above with a real camera unit K, and/or with virtual, i.e. simulated sensors.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Test setup
20 Superordinate intelligence
100 Test bench
COM Communication interface
ECU Control unit
K Camera unit
M Image output unit
P Processor
a, b, c, d, e Method steps

1. A system, comprising;
a camera unit;
a control unit; and
a test setup for testing the control unit, wherein the test setup comprises a processor and an image output unit;
wherein the processor is configured to manipulate image data to simulate an error of the camera unit and to output, on the image output unit, the manipulated image data in the form of an image detectable via camera optics;
wherein the camera unit is configured to detect, via the camera optics, the outputted image data simulating the error of the camera unit; and
wherein the control unit is configured to receive, from the camera unit, camera image data simulating the error of the camera unit.

2. The system according to claim 1, wherein the error is an electrical error of the camera unit.

3. The system according to claim 1, wherein the camera unit comprises the camera optics, wherein the camera optics include a lens and an imager, and wherein the camera image data received from the camera unit includes raw data output by the imager.

4. The system according to claim 1, wherein the camera unit comprises the camera optics, wherein the camera optics include a lens and an imager, wherein the camera unit further comprises a camera processor configured to process raw data output by the imager, and wherein the camera image data received from the camera unit includes processed data output by the camera processor.

5. The system according to claim 1, wherein the error relates to the failure of at least one color channel.

6. The test setup according to claim 1, wherein the camera unit comprises the camera optics, wherein the camera optics include an imager, and wherein the error relates to an error of at least one pixel of the imager.

7. The test setup according to claim 6, wherein the resolution of the image output unit (M) is greater than that of the imager.

8. The system according to claim 1, wherein the error relates to at least one lens error.

9. The system according to claim 1, wherein the processor is configured to generate synthetic image data simulating predetermined errors of the camera unit and to output the synthetic image data on the image output unit.

10. The system according to claim 9, wherein the predetermined errors are stored in a database that is connected to the processor via a communication interface.

11. The system according to claim 9, further comprising:
a higher level intelligence configured to control the simulation of the errors.

12. A method for testing a control unit, comprising:
generating synthetic image data detectable via camera optics of a camera unit;
outputting the synthetic image data on an image output unit;
detecting the image data output on the image output unit by the camera optics;
outputting camera image data by the camera unit; and
receiving the camera image data by the control unit,
wherein the synthetic image data are designed such that the camera image data output by the camera unit simulates an error of the camera unit.

13. The method according to claim 12, wherein the reaction of the control unit to the simulated error of the camera unit is detected and is transmitted to a higher level intelligence.
